(19) United States
(12) Patent Application Publication
(10) Pub. No.: US 2018/0319238 A1
(43) Pub. Date: Nov. 8, 2018

(54) Height Adjustable Transporting Trailer

(71) Applicant: William Joe Denton, III, Wilson, AK (US)

(72) Inventor: William Joe Denton, III, Wilson, AK (US)

(21) Appl. No.: 16/034,814

(22) Filed: Jul. 13, 2018

Related U.S. Application Data
(63) Continuation-in-part of application No. 29/577,340, filed on Sep. 12, 2016, now Pat. No. D826786.

(51) Int. Cl. B60G 17/04; B62D 63/08; B62D 63/06; B60P 3/32

(52) U.S. Cl. CPC B60G 17/04; B62D 63/08; B62D 63/068; B60G 2500/30; B60G 2202/15; B60G 2300/04; B60P 3/32

(57) ABSTRACT

A height adjustable transporting trailer includes a main frame, a plurality of left wheel assemblies, a plurality of right wheel assemblies, and a hydraulic system. The plurality of left wheel assemblies and the plurality of right wheel assemblies are pivotally connected to a rear section of the main frame through a fixed end of a control arm. A free end of the control arm retracts and extends the plurality of left wheel assemblies and the plurality of right wheel assemblies with a hydraulic cylinder of each left wheel assembly and each right wheel assembly that is operated through the hydraulic system. Resultantly, the height adjustable transporting trailer can efficiently load/unload a manufactured house as the main frame can be lowered and positioned underneath the foundation of the manufactured house.

### FIELD OF THE INVENTION

The present invention relates generally to a transporting trailer. More specifically, the present invention is a height adjustable transporting trailer that efficiently loads and unloads a manufactured house during the transportation process.

### BACKGROUND OF THE INVENTION

Manufactured houses are generally built in a factory site and then transported into the owner's site through a transporting trailer. The transportation process is completed through a heavy-duty truck due to the weight and the size of the manufactured house as the transporting trailer is hauled by the heavy-duty truck. Even though the actual moving phase of the manufactured houses is relatively easy, many builders encounter difficulties during loading and unloading phase of the manufactured houses. Due to the large volume and size of the manufactured houses, builders may have to spend additional money to rent loading/unloading utility vehicles. Furthermore, builders spend additional money in repair that may occur during the loading/unloading process and added time that ultimately reduces the profit margin.

It is therefore an objective of the present invention to provide a height adjustable transporting trailer. More specifically, the present invention can easy slide under the foundation of the manufactured house during the loading/unloading phase of the manufactured house due to the hydraulic system that is intergraded into the frame and the wheel assemblies of the present invention. The hydraulic system also allows the frame to be lifted away from the ground level during the moving phase to provide enough ground clearance. The present invention can be hauled with any types of transporting vehicles as long as transporting vehicles are able to operatively couple with the hydraulic system of the present invention that operates the upward and downward movement of the frame in relation to the wheel assemblies.

### BRIEF DESCRIPTION OF THE DRAWINGS

FIG. 1 is a perspective view of the present invention.

FIG. 2 is a top view of the present invention.

FIG. 3 is a left view of the present invention, wherein the present invention is at the extended position.

FIG. 4 is a left view of the present invention, wherein the present invention is at the retracted position.

FIG. 5 is a detail view of the rear section of the present invention, showing the connection between the main frame and the plurality of left wheel assemblies and the plurality of right wheel assemblies without the pair of dual wheels.

FIG. 6 is an exploded view of the one of the wheel assembly of the present invention.

FIG. 7 is another detail view of the rear section of the present invention, showing the connection between the main frame and the plurality of left wheel assemblies and the plurality of right wheel assemblies without the pair of dual wheels.

FIG. 8 is a basic schematic showing the in fluid communication between the hydraulic cylinder of each wheel assembly and the hydraulic line system.

### DETAIL DESCRIPTIONS OF THE INVENTION

All illustrations of the drawings are for the purpose of describing selected versions of the present invention and are not intended to limit the scope of the present invention.

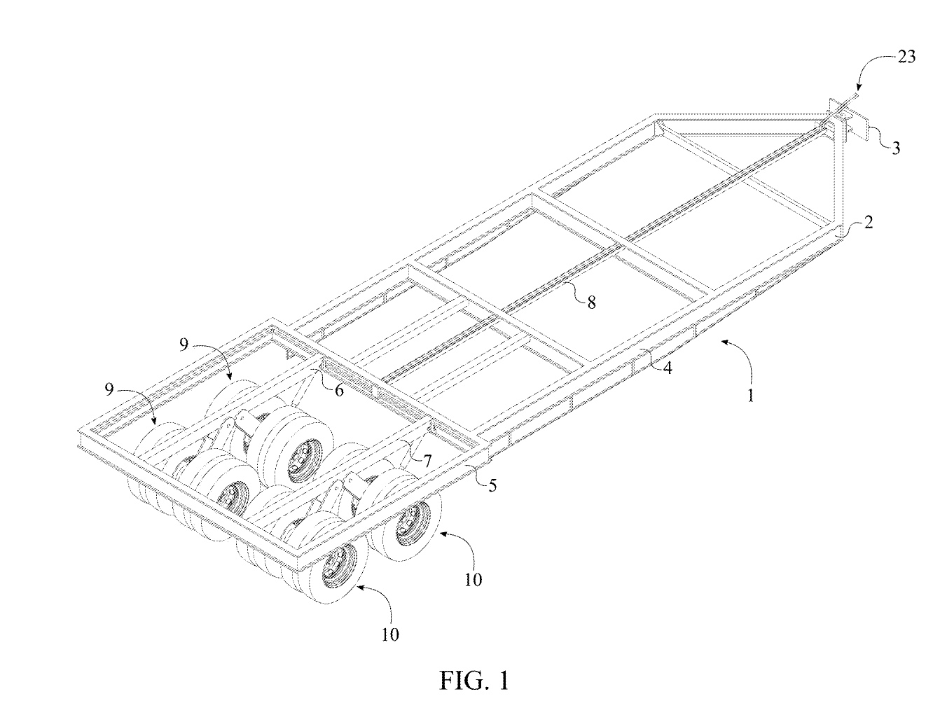

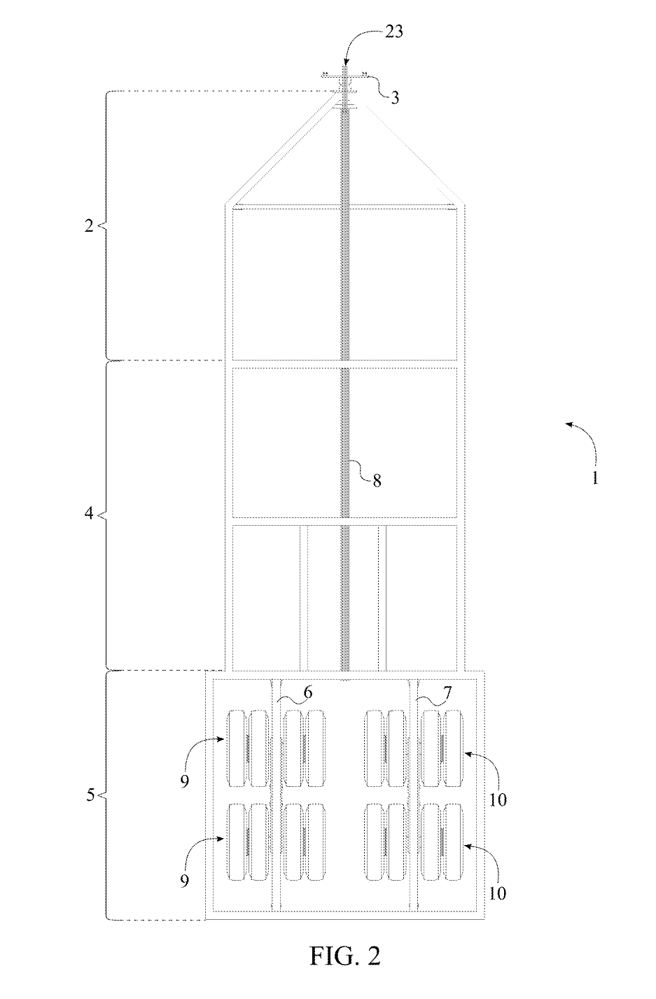

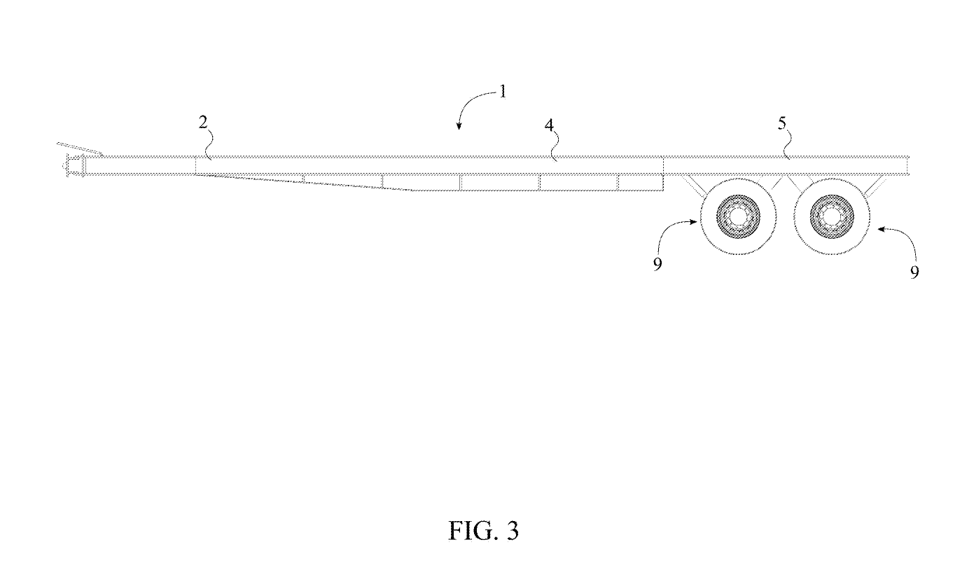

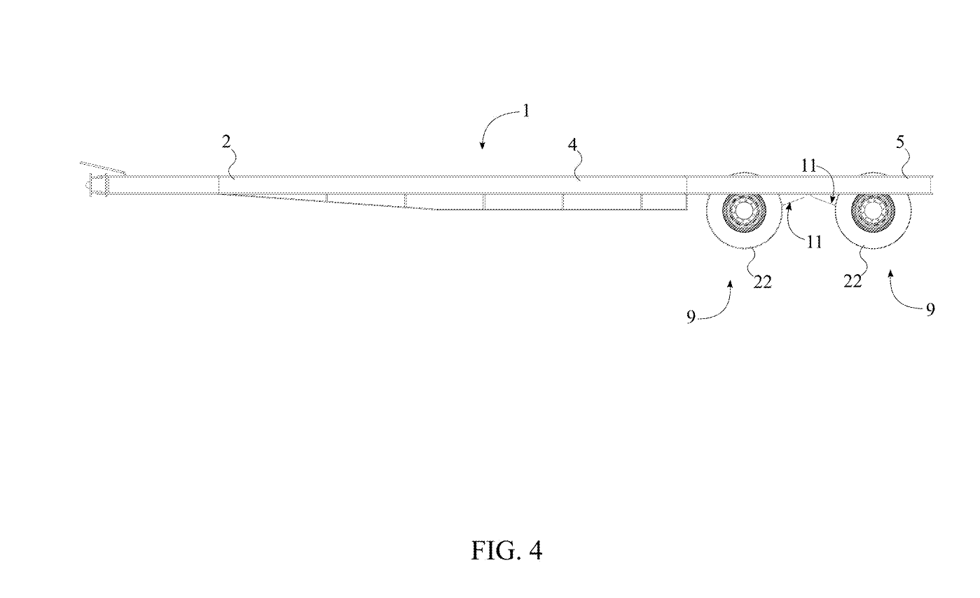

The present invention is a height adjustable transporting trailer that can easily load and unload a manufactured house. The present invention enables an individual (e.g. a manufactured house builder, a manufactured house owner, or a transporting vehicle driver) to easily load, transport, and unload a manufactured house without having to utilized other utility vehicles. More specifically, the present invention allows an individual to transport any types of houses as the manufactured houses can include, but are not limited to, site-built houses, modular houses, and mobile houses. The present invention comprises a main frame 1, a plurality of left wheel assemblies 9, a plurality of right wheel assemblies 10, and a hydraulic line system 23 as shown in FIG. 1-2. In reference to the general configuration of the present invention, the plurality of left wheel assemblies 9 and the plurality of right wheel assemblies 10 are mounted to a rear section 5 of the main frame 1 and operate between a retracted position and an extended position through the hydraulic line system 23 as shown in FIG. 3-4. As a result, the present invention can efficiently load and unload a manufactured house as the main frame 1 can be lowered and positioned underneath a manufactured house. A front section 2 of the main frame 1 is rotatably engaged with a transporting vehicle that can operatively couple with the hydraulic line system 23, wherein the transporting vehicle is able to transport the present invention from one location to another and operate the main frame 1 in between the retracted position and the extended position.

The main frame 1, which provides surface area to place a manufactured house, is an elongated and leveled member so that a manufactured house can be securely placed upon. In reference to FIG. 1-2, the main frame 1 comprises a vehicle attachment 3, an intermediary section 4, a left support beam 6, a right support beam 7, and a conduit track 8 in addition to the front section 2 and the rear section 5. More specifically, the front section 2 is adjacently connected with the intermediary section 4. The rear section 5 is adjacently connected with the intermediary section 4 and positioned opposite of the front section 2. The left support beam 6 and the right support beam 7 are connected along the rear section 5 in such a way that the left support beam 6 and the right support beam 7 extend from a back end of the rear section 5 to the intermediary section 4. The conduit track 8 starts from the rear section 5 and extends along the intermediary section 4 and the front section 2, wherein the conduit track 8 provides empty space for the placement of the hydraulic line system 23. The vehicle attachment 3 is rotatably connected to the front section 2 and positioned opposite of the intermediary section 4. The vehicle attachment 3 is preferably a mechanical connecting member that secures the main frame 1 to the transporting vehicle so that the present invention can be transported from one location to another. Furthermore, the main frame 1 is supported with a plurality of load bearing brackets and additional supporting beams in order to improve the structural integrity of the main frame 1. The main frame 1 is preferably made of steel or any other type of heavy duty material so that the main frame 1 is able to withstand the weight of a manufactured house.

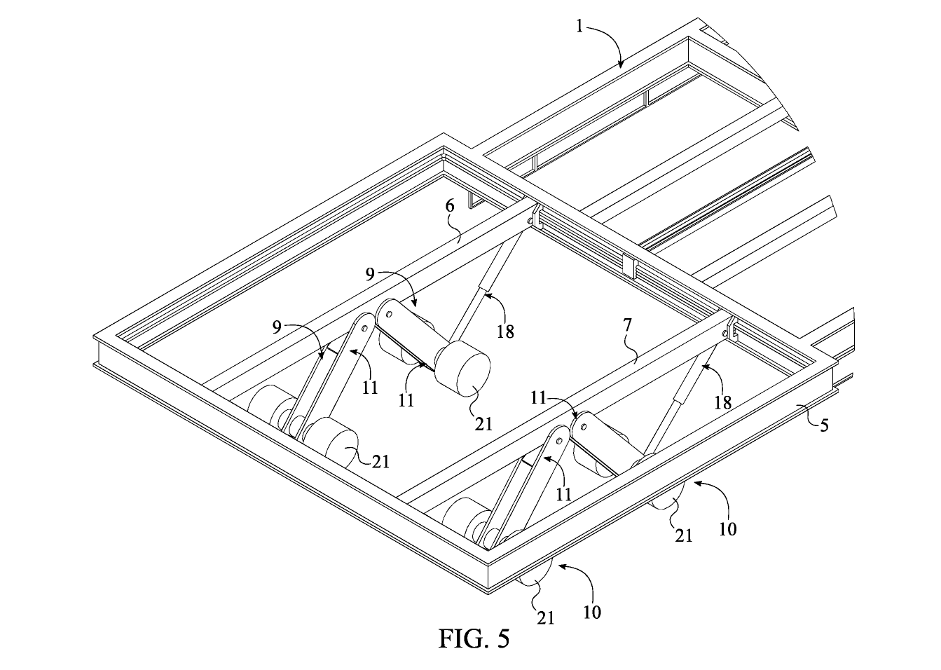

The plurality of left wheel assemblies 9 and the plurality of right wheel assemblies 10 facilitate the movement or transportation of the main frame 1 while supporting the weight of a manufactured house. The plurality of left wheel assemblies 9 and the plurality of right wheel assemblies 10 each comprise a control arm 11, a hydraulic cylinder 18, a straight axle assembly 21, and a pair of dual wheels 22 as shown in FIG. 5-7. In reference to each left wheel assembly 9 and each right wheel assembly 10, a fixed end 12 of the control arm 11 is pivotally mounted to the rear section 5. The hydraulic cylinder 18 is telescopically mounted in between a free end 13 of the control arm 11 and the rear section 5, wherein the hydraulic cylinder 18 is in fluid communication with the hydraulic line system 23. The straight axle assembly 21 is mounted to the free end 13 and positioned opposite of the fixed end 12 while the pair of dual wheels 22 is rotatably mounted to the straight axle assembly 21.

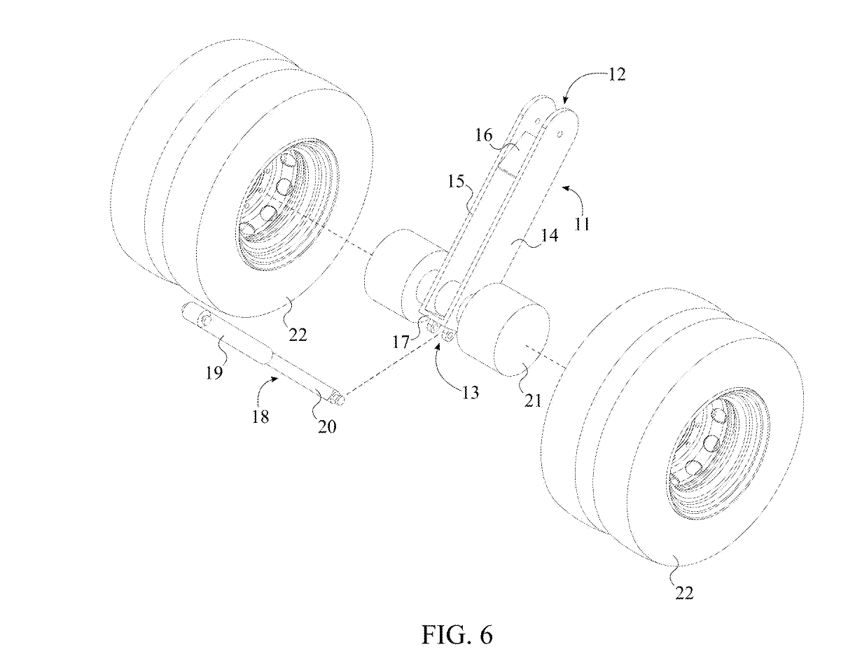

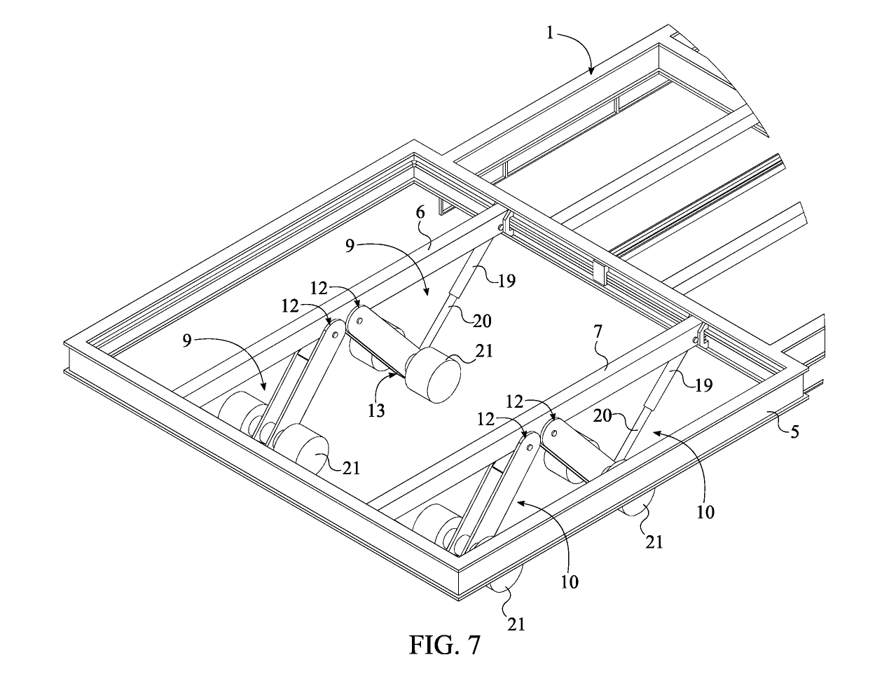

The control arm 11 functions as a pivoting structural member for the plurality of left wheel assemblies 9 and the plurality of right wheel assemblies 10 with respect to the main frame 1. In reference to FIG. 6-7, the control arm 11 comprises a first lateral arm 14, a second lateral arm 15, an arm rest 16, and a cylinder plate 17. More specifically, the first lateral arm 14 and the second lateral arm 15 are pivotally mounted to the rear section 5, about the fixed end 12. The cylinder plate 17 is terminally connected to the first lateral arm 14 and the second lateral arm 15, about the free end 13. The hydraulic cylinder 18, which comprises a piston rod 20 and a housing 19, is telescopically mounted in between the cylinder plate 17 and the rear section 5. More specifically, the piston rod 20 is telescopically interfitted with the housing 19 in order to complete the hydraulic cylinder 18. Consequently, the housing 19 is pivotally mounted to the rear section 5, and the piston rod 20 is pivotally mounted to the cylinder plate 17. The hydraulic cylinder 18 is then able to move the control arm 11 in between the retracted position and the extended position as the first lateral arm 14 and the second lateral arm 15 are pivotally mounted to the rear section 5, about the fixed end 12. The arm rest 16 that allows the main frame 1 to be positioned upon is angularly connected in between the first lateral arm 14 and the second lateral arm 15, in between the fixed end 12 and the free end 13. When the present invention is at the retracted position, the main frame 1 sits atop the arm rest 16 to reduce the amount of pressure that is applied upon the plurality of left wheel assemblies 9 and the plurality of right wheel assemblies 10.

In reference to FIG. 7, the fixed end 12 of the control arm 11 for each left wheel assembly 9 is pivotally mounted to the left support beam 6. The free end 13 of the control arm 11 for each left wheel assembly 9 is mounted to the left support beam 6 with the hydraulic cylinder 18 of each left wheel assembly 9, completing the plurality of left wheel assemblies 9 of the present invention. Similarly, the fixed end 12 of the control arm 11 for each right wheel assembly 10 is pivotally mounted to the right support beam 7. The free end 13 of the control arm 11 for each right wheel assembly 10 being mounted to the right support beam 7 with the hydraulic cylinder 18 of each right wheel assembly 10, completing the plurality of right wheel assemblies 10 of the present invention.

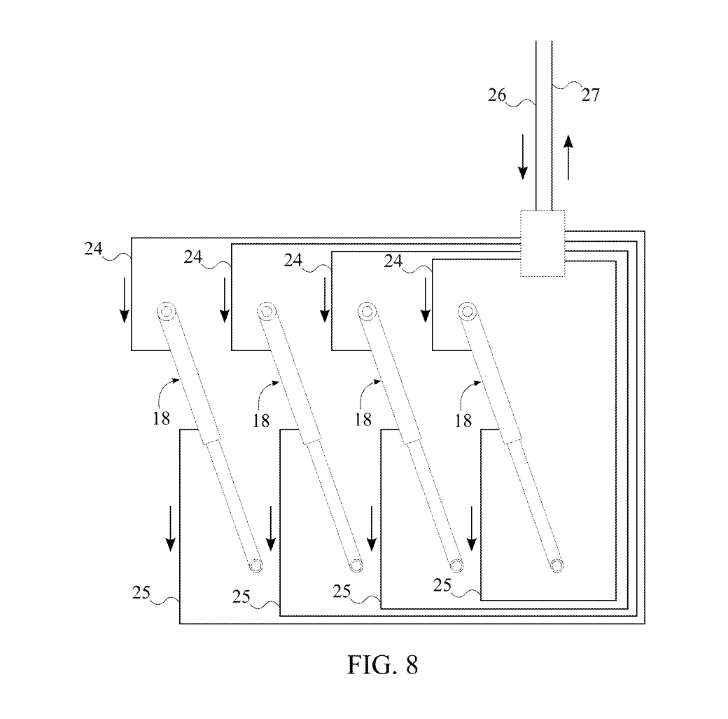

The hydraulic line system 23 is in fluid communication with the hydraulic cylinder 18 of each left wheel assembly 9 and each right wheel assembly 10. The hydraulic line system 23 is configured to operate through a hydraulic pump unit of the transporting vehicle. If the transporting vehicle is not equipped with a hydraulic pump unit, the hydraulic line system 23 can be operated through an external hydraulic pump unit. In reference to FIG. 8, the hydraulic line system 23 comprises a plurality of sub-pressure lines 24, a plurality of sub-return lines 25, a main pressure line 26, and a main return line 27. The plurality of sub-pressure lines 24 and the plurality of sub-return lines 25 are integrated into the rear section 5. The main pressure line 26 and the main return line 27 are extended along the conduit track 8 as the conduit track 8 provides sufficient placement space for the main pressure line 26 and the main return line 27. As a result, the main pressure line 26 and the main return line 27 can efficiently function without interfering with a manufactured house that may be positioned upon the main frame 1. The main pressure line 26 is in fluid communication with the plurality of sub-pressure lines 24 while the main return line 27 is in fluid communication with the plurality of sub-return lines 25. Due to the configuration of the hydraulic line system 23, each sub-pressure line 24 and each sub-return line 25 are in fluid communication with the hydraulic cylinder 18 of each left wheel assembly 9 and each right wheel assembly 10. As a result, hydraulic line system 23 in conjunction with the hydraulic pump unit is able to operate the main frame 1 in between the retracted position and the extended position.

When the present invention is at the retracted position, the main frame 1 can be slid underneath the manufactured house in order to complete a loading phase. The main frame 1 is lowered below the manufactured house to complete the loading phase as the manufactured house is generally elevated from ground level during construction. Once the main frame 1 is aligned with the manufactured house, the present invention switches into the extended positioned. The extended position then lifts the manufactured house with the main frame 1 and provide ground clearance for the main frame 1 to initiate a moving phase. Once the manufactured house is at the destination and aligned with a foundation, the present invention switches from the extended position to the retracted positioned to unload the manufactured house onto the foundation, wherein the main frame 1 can be pulled underneath the manufactured house.

Although the invention has been explained in relation to its preferred embodiment, it is to be understood that many other possible modifications and variations can be made without departing from the spirit and scope of the invention as hereinafter claimed.

What is claimed is:

1. A height adjustable transporting trailer comprises:
a main frame;
a plurality of left wheel assemblies;
a plurality of right wheel assemblies;
a hydraulic line system;
the plurality of left wheel assemblies and the plurality of right wheel assemblies each comprise a control arm, a hydraulic cylinder, a straight axle assembly, and a pair of dual wheels;
a fixed end of the control arm being pivotally mounted to a rear section of the main frame;
the straight axle assembly being mounted to a free end of the control arm, opposite of the fixed end;
the pair of dual wheels being rotatably mounted to the straight axle assembly;
the hydraulic cylinder being telescopically mounted in between the free end and the rear section; and
the hydraulic cylinder being in fluid communication with the hydraulic line system.

2. The height adjustable transporting trailer as claimed in claim 1 comprises:
the main frame further comprises a front section, an intermediary section, a left support beam, and a right support beam;
the front section being adjacently connected with the intermediary section;
the rear section being adjacently connected with the intermediary section, opposite of the front section; and
the left support beam and the right support beam being connected along the rear section.

3. The height adjustable transporting trailer as claimed in claim 2 comprises:
a vehicle attachment; and
the vehicle attachment being rotatably connected to the front section, opposite of the intermediary section.

4. The height adjustable transporting trailer as claimed in claim 1 comprises:
the rear section comprises a left support beam and a right support beam;
the fixed end of the control arm for each left wheel assembly being pivotally mounted to the left support beam;
the free end of the control arm for each left wheel assembly being mounted to the left support beam with the hydraulic cylinder of each left wheel assembly;
the fixed end of the control arm for each right wheel assembly being pivotally mounted to the right support beam; and
the free end of the control arm for each right wheel assembly being mounted to the right support beam with the hydraulic cylinder of each right wheel assembly.

5. The height adjustable transporting trailer as claimed in claim 1 comprises:
the control arm for each left wheel assembly and each right wheel assembly comprises a first lateral arm, a second lateral arm, an arm rest, and a cylinder plate;
the first lateral arm and the second lateral arm being pivotally mounted to the rear section, about the fixed end;
the arm rest being connected in between the first lateral arm and the second lateral arm, in between the fixed end and the free end;
the cylinder plate being terminally connected to the first lateral arm and the second lateral arm, about the free end; and
the hydraulic cylinder being telescopically mounted in between the cylinder plate and the rear section.

6. The height adjustable transporting trailer as claimed in claim 5 comprises:
the hydraulic cylinder comprises a housing and a piston rod;
the piston rod being telescopically interfitted with the housing;
the housing being pivotally mounted to the rear section; and
the piston rod being pivotally mounted to the cylinder plate.

7. The height adjustable transporting trailer as claimed in claim 1 comprises:
the hydraulic line system comprises a plurality of sub-pressure lines, a plurality of sub-return lines, a main pressure line, and a main return line;
the main frame further comprises a front section, an intermediary section, and a conduit track;
the conduit track being extended along the intermediary section and the front section from the rear section;
the plurality of sub-pressure lines and the plurality of sub-return lines being integrated into the rear section;
the main pressure line and the main return line being extended along the conduit track;
the main pressure line being in fluid communication with the plurality of sub-pressure lines;
the main return line being in fluid communication with the plurality of sub-return lines; and
each sub-pressure line and each sub-return line being in fluid communication with the hydraulic cylinder of each left wheel assembly and each right wheel assembly.
